(19) United States
(12) Patent Application Publication
(10) Pub. No.: US 2007/0232356 A1
(43) Pub. Date: Oct. 4, 2007

(54) Plagiarization-proof function for a SIM card

(75) Inventor: Pen-Lo Wang, Longtan Township (TW)

Correspondence Address: Troxell Law Office Pllc, Suite 1404, 5205 Leesburg Pike, Falls Church, VA, 22041, US

(73) Assignee: A-Men Technology Corporation

(21) Appl. No.: 11/391,416

(22) Filed: Mar. 29, 2006

(51) Int. Cl. H04B 1/38

(52) U.S. Cl. 455/558

(57) ABSTRACT

The present invention is a plagiarization-proof function for a SIM card, wherein a telecommunication service data of a telecommunication vendor is processed with a data encryption, and is then saved on an identifiable service identification card which can be accessed for a registration data. Next, the registration data is entered into a mobile phone module and a SIM card module, through the mobile phone module or a computer program. Accordingly, through a service of logging and registration provided by the telecommunication vendor, the registration data accessed by the subscriber is submitted to the telecommunication vendor to request for a registration and a provision of communication service, through a logging and registration program of the SIM card module, so as to achieve purposes of preventing from being plagiarized and of expanding the communication service.

### BACKGROUND OF THE INVENTION

(a) Field of the Invention

The present invention relates to a plagiarization-proof function for a SIM (Subscriber Identity Module) card, and more particularly to a plagiarization function for a SIM card wherein after an encrypted data of a service identification card is entered by a subscriber, packets of secured instructions will be transmitted from a service server to a registration server of a telecommunication vendor for requesting registration, and for checking whether that data has been registered for use through the registration server. If the data has not been registered yet, then a message of confirmation will be responded, and a proper communication service will be provided to achieve purposes of preventing from being plagiarized and of expanding the communication services.

(b) Description of the Prior Art

As the continuing advancement of modern communication technology, a function of ordinary SIM card of a mobile phone has achieved to a switch of various application services, through turning on and off a power of the mobile phone and directly entering a password. In addition, there have already been a lot of products of a switching device used to change different line numbers, which can be chosen in the market. However, as the SIM card of mobile phone should be matched with a telecommunication vendor, there are still a lot of limitations in functions of subscriber identify modules provided by the telecommunication vendor, through the method of turning on and off the power of mobile phone and directly entering the password, except a choice among multiple line numbers and qualities of communication. Furthermore, there also exists a problem that it cannot prevent the SIM card from being stolen for use.

Accordingly, how to remove the aforementioned problems is a technical issue to be solved by the present inventor.

### SUMMARY OF THE INVENTION

The primary object of the present invention is to provide a plagiarization-proof function for a SIM card, wherein after an encrypted data of a service identification card is entered by a subscriber, packets of secured instructions will be transmitted from a service server to a registration server of a telecommunication vendor for requesting registration, and for checking whether that data has been registered for use through the registration server. If the data has not been registered yet, then a message of confirmation will be responded, and a proper communication service will be provided to achieve purposes of preventing from being plagiarized and of expanding the communication services.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of the present invention.

FIG. 2 shows a block diagram of the present invention.

FIG. 3 shows a schematic view of the present invention.

FIG. 4 shows a schematic view of an embodiment of the present invention.

### DETAILED DESCRIPTION OF THE PREFERRED EMBODIMENTS

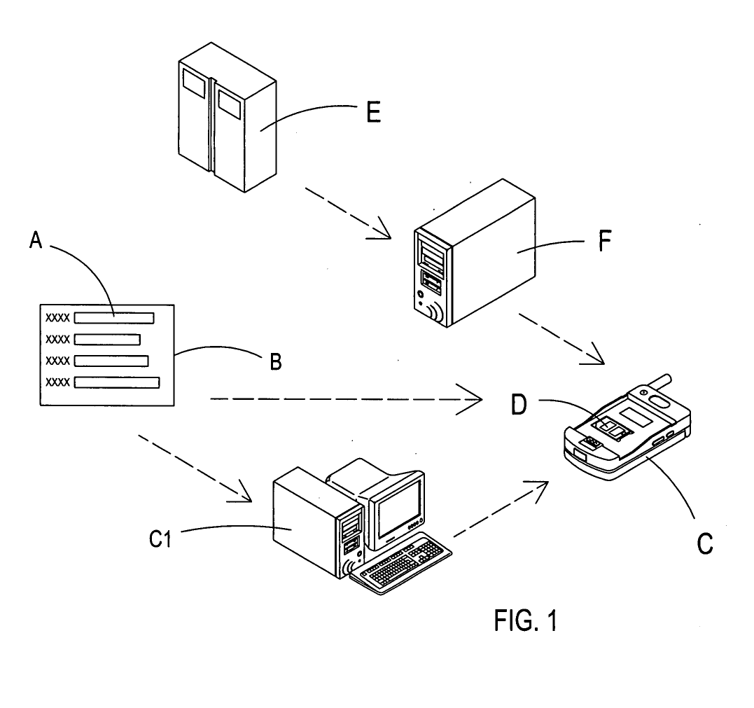

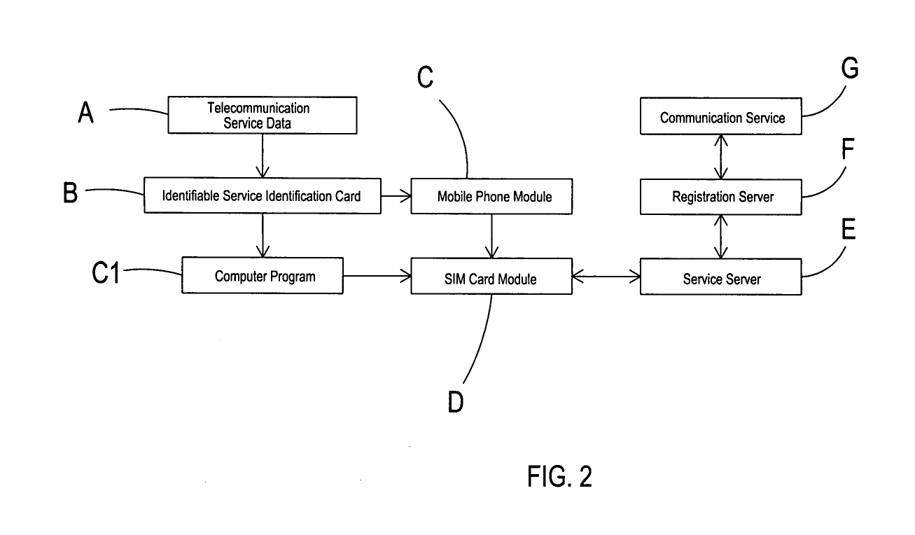

Referring to FIG. 1 and FIG. 2, a plagiarization-proof function for a SIM card comprises a telecommunication service data A of a telecommunication vendor, an identifiable service identification card B, a mobile phone module C, a SIM card module D, a service server E, and a registration server F, wherein the telecommunication service data A of the telecommunication vendor is first processed with a data encryption, and is then saved on the identifiable service identification card B which can be accessed by a subscriber for a registration data. Next, the registration data is entered into the mobile phone module C and the SIM card module D, through the mobile phone module C or a computer program C1.

Accordingly, after entering the registration data accessed by the subscriber through the service server E and a registration and logging of the telecommunication vendor, a request for a registration and a provision of communication service G will be submitted to the registration server F of the telecommunication vendor, through a logging and registration program of the SIM card module D, such that the SIM card module D can be provided with the functions of preventing from being plagiarized and of expanding the communication service G.

Referring to FIG. 1 and FIG. 2, after the subscriber has accessed the telecommunication service data A, and the identifiable service identification card B which is processed with the data encryption, provided by the telecommunication vendor, he or she can enter the registration data on the identifiable service identification card B through the mobile phone module B and the computer program C1 into the mobile phone module C and the SIM card module D, to achieve the purposes of preventing from being plagiarized and of expanding the communication service G.

The registration data on the service identification card B provided by the telecommunication vendor is entered into the mobile phone module C and the SIM card module D through the subscriber, and is then submitted to the registration server F of the telecommunication vendor for requesting for the registration and the provision of communication service G, through the service server E and the registration and logging of the telecommunication vendor, and then through the logging and registration program of the SIM card module D.

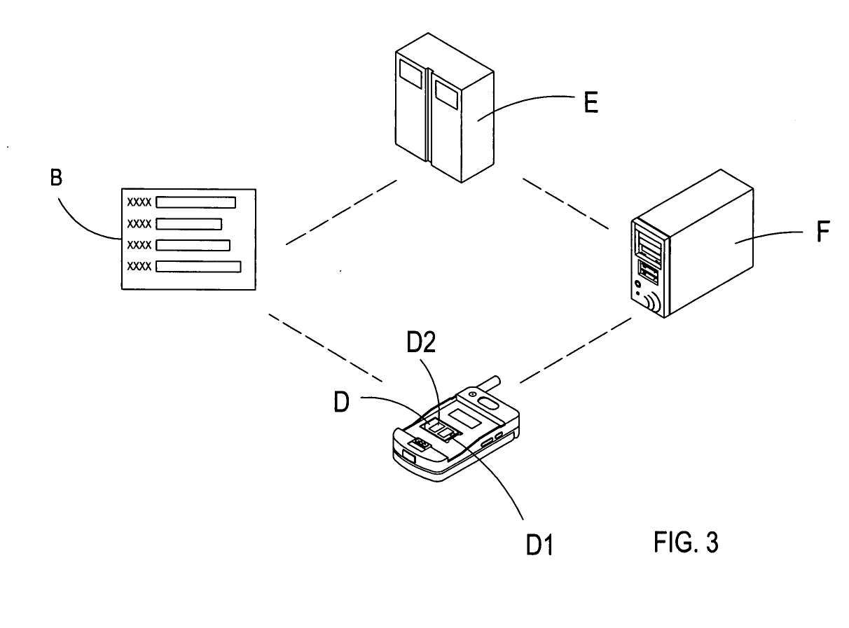

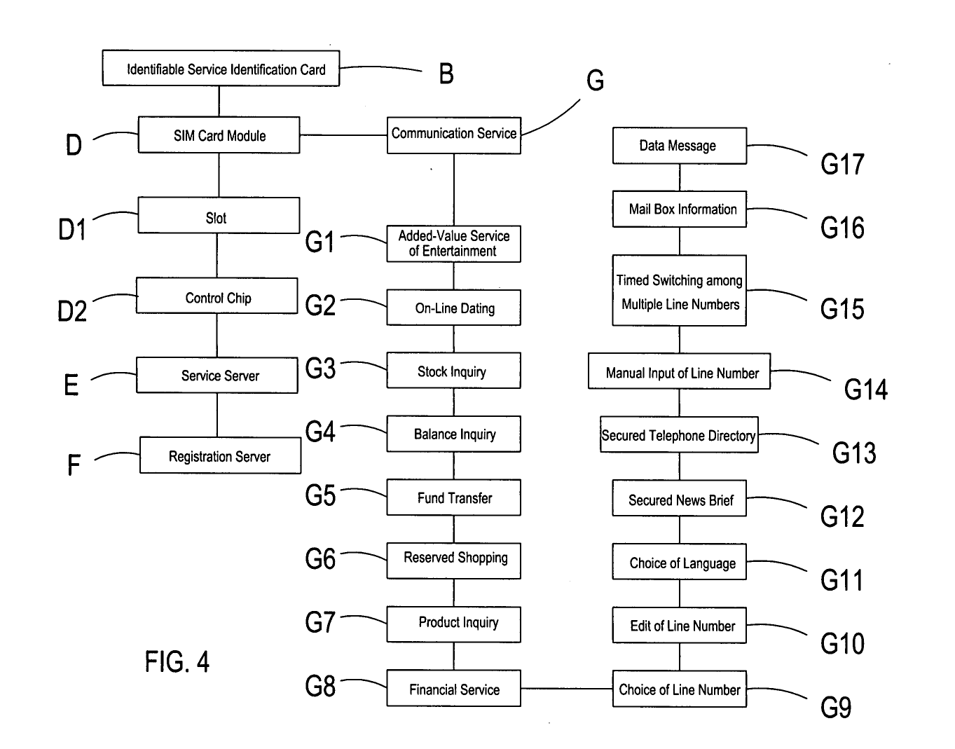

Referring to FIG. 3 and FIG. 4, after the registration data on the service identification card B is entered by the subscriber, the request for registration and provision of communication service is submitted to the registration server F of the telecommunication vendor, through transmitting packets of secured instructions by the service server E, and in the mean time, a checking of whether that data has been logged for use is performed through the registration server F. If the data has not been logged yet, then a message of confirmation will be responded and a proper communication service G will be provided at the same time, so as to achieve the purposes of preventing from being plagiarized and of expanding the communication service G.

The SIM card module includes a slot D1, a control chip D2, and other related structures which can be provided with a function of using multiple line numbers with one card, and a function of using multiple line numbers with multiple cards, and can expand and integrate the communication service G, such that the SIM card module can achieve the purpose of expanding the communication service G.

In addition, the communication service G further includes an added-value service of entertainment G1, an on-line dating G2, a stock inquiry G3, a balance inquiry G4, a fund transfer G5, a reserved shopping G6, a product inquiry G7, a financial service G8, a choice of line number G9, an edit of line number G10, a choice of language G11, a secured news brief G12, a secured telephone directory G13, a manual input of line number information G14, a timed automatic switching among multiple line numbers G15, a mail box information G16, a data message G17, and other related system interfaces which can match with the SIM card module to achieve the integration and expansion of the communication service G.

To further manifest the advancement and practicability of the present invention, the present invention is compared with a conventional application as below:

### Shortcomings of a Conventional Application

1. Only a switch to different line numbers and a limitation to a communication service of each telecommunication vendor are provided to a mobile phone, by turning on and off a power of the mobile phone and directly entering a password.
2. There is still a limitation to functions of SIM card in a subscriber identity module provided by a telecommunication vendor, thereby being unable to achieve a purpose of integrating functions of SIM card.
3. There is still a problem that a SIM card can be stolen and it is unable for a subscriber identity module provided by a telecommunication vendor to achieve purposes of securing personal data and expanding functions.

### Advantages of the Present Invention

1. Through a control chip of mobile phone module and SIM card module, communication application service interfaces can be additionally installed, expanded, and integrated, by cooperating with a telecommunication vendor.
2. Through a telecommunication service data, a service identification card, a service server, a registration server, and a chip provided by a telecommunication vendor, a mobile phone module and a SIM card module can achieve purposes of preventing from being plagiarized and of expanding and integrating a communication service.
3. Through a registration and logging service from a service identification card, a registration server, and a service server provided by a telecommunication vendor, personal data can be secured, and through a cooperation with the telecommunication vendor, a communication service can be additionally installed, expanded, and integrated.
4. It is provided with advancement and practicability.
5. It is provided with industrial competitiveness.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A plagiarization-proof function for a SIM card comprising a telecommunication service data provided by a telecommunication vendor, being processed with a data encryption and then saved on an identifiable service identification card which can be accessed; the accessible identifiable service identification card from which a registration data thereof being accessed by a subscriber, and then being entered into a SIM card module of a mobile phone module through the mobile phone module or a computer program; accordingly, through a service of registration and logging provided by the telecommunication vendor, the registration data accessed by the subscriber being submitted to the telecommunication vendor for requesting for a registration and a provision of communication service through a logging and registration program of the SIM card module, after entering the registration data, such that the SIM card module can achieve purposes of preventing from being plagiarized and of expanding the related communication service at the same time.

2. The plagiarization-proof function for a SIM card according to claim 1, wherein the SIM card module further includes a slot, a control chip, and other related structures which can be provided with a function of using multiple line numbers with one card, and a function of using multiple line numbers with multiple cards, and can expand and integrate the communication service.

3. The plagiarization-proof function for a SIM card according to claim 1, wherein the communication service further includes an added-value service of entertainment, an on-line dating, a stock inquiry, a balance inquiry, a fund transfer, a reserved shopping, a product inquiry, a financial service, a choice of line number, an edit of line number, a choice of language, a secured news brief, a secured telephone directory, a manual input of line number information, a timed automatic switching among multiple line numbers, a mail box information, a data message, and other related service system interfaces which can match with the SIM card module and the mobile phone module and can be operated and accessed.

4. The plagiarization-proof function for a SIM card according to claim 2, wherein the communication service further includes an added-value service of entertainment, an on-line dating, a stock inquiry, a balance inquiry, a fund transfer, a reserved shopping, a product inquiry, a financial service, a choice of line number, an edit of line number, a choice of language, a secured news brief, a secured telephone directory, a manual input of line number information, a timed automatic switching among multiple line numbers, a mail box information, a data message, and other related service system interfaces which can match with the SIM card module and the mobile phone module and can be operated and accessed.
